(19) United States
(12) Patent Application Publication
(10) Pub. No.: US 2018/0198951 A1
(43) Pub. Date: Jul. 12, 2018

(54) IMAGE READING APPARATUS, IMAGE FORMING APPARATUS, AND METHOD FOR GENERATING IMAGE DATA

(71) Applicants: KABUSHIKI KAISHA TOSHIBA, Tokyo (JP); TOSHIBA TEC KABUSHIKI KAISHA, Tokyo (JP)

(72) Inventor: Satoshi ONUMA, Yokohama Kanagawa (JP)

(21) Appl. No.: 15/401,578

(22) Filed: Jan. 9, 2017

(51) Int. Cl. H04N 1/387; H04N 1/00; H04N 1/04

(52) U.S. Cl. CPC H04N 1/3878; H04N 1/00708; H04N 1/00718; H04N 2201/0081; H04N 1/00748; H04N 1/0464; H04N 2201/0094; H04N 1/00737

(57) ABSTRACT

An image reading apparatus according to an embodiment includes an image reading unit that generates image data by reading an object. A background unit has a plurality of different background surfaces. A control unit determines whether the object has a non-standard size. When the object is determined to have a non-standard size, the image reading unit faces the object with a first surface, of the plurality of different background surfaces that is distinguishable from the object, positioned behind the object for reading. When the object is determined to not have a non-standard size, the image reading unit faces the object with a second surface, with a different color than the first surface of the plurality of different background surfaces, positioned behind the object for reading.

### FIELD

Embodiments described herein relate generally to an image reading apparatus, an image forming apparatus, and a method for generating image data.

### BACKGROUND

An image reading apparatus reads an image on a sheet using an image sensor such as a charge coupled device (CCD) or a contact image sensor (CIS). In such an image reading apparatus, when reading a sheet that is not a standard size, such as a name card or a receipt, the sheet is read as a standard size. However, if the non-standard size sheet is read as a standard size, there is a possibility that the image includes a portion in which there is no sheet.

### DESCRIPTION OF THE DRAWINGS

FIG. 1 is a perspective diagram illustrating an example configuration of an image forming apparatus according to an embodiment.

FIG. 2 illustrates an example schematic configuration of the image forming apparatus.

FIG. 3 illustrates an example internal configuration of an image reading unit.

FIG. 4 illustrates an example functional-block configuration of the image reading unit.

FIG. 5 illustrates a reading portion of a first reading unit.

FIG. 6 illustrates a reading position of a second reading unit.

FIGS. 7A to 7C illustrate an example configuration in which an automatic document feeder detects a size of a sheet.

FIG. 8 is an example table that the automatic document feeder uses to detect the size of the sheet.

FIGS. 9-11 are flowcharts illustrating an example sequence of operations for reading the sheet.

### DETAILED DESCRIPTION

An image reading apparatus according to an embodiment includes an image reading unit that generates image data by reading an object. A background unit has a plurality of different background surfaces. A control unit determines whether the object has a non-standard size. When the object is determined to have a non-standard size, the image reading unit faces the object with a first surface, of the plurality of different background surfaces that is distinguishable from the object, positioned behind the object for reading. When the object is determined to not have a non-standard size, the image reading unit faces the object with a second surface, with a different color than the first surface of the plurality of different background surfaces, positioned behind the object for reading.

Hereinafter, an image reading apparatus, an image forming apparatus, and an image reading method of the embodiment will be described with reference to drawings.

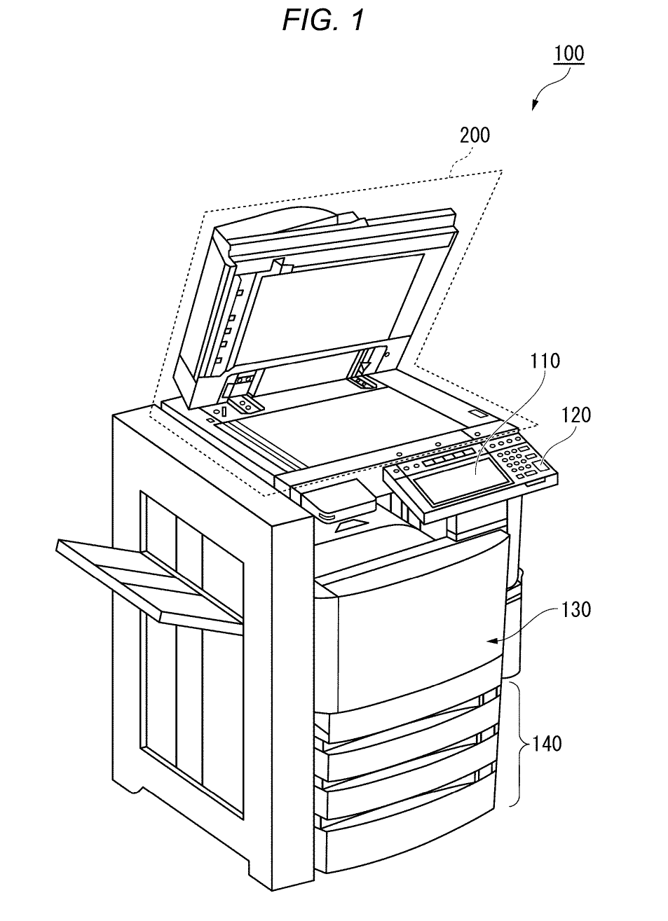

FIG. 1 is an perspective diagram illustrating an example configuration of an image forming apparatus 100 according to an embodiment.

The image forming apparatus 100 is, for example, a multifunction peripheral. The image forming apparatus 100 includes a display 110, a control panel 120, a printer unit 130, a sheet housing unit 140, and an image reading unit 200. The printer unit 130 of the image forming apparatus 100 may be a device which forms a toner image, or may be an ink jet type device.

The image forming apparatus 100 forms an image on a sheet using a developer such as toner. The sheet is, for example, a paper, or a label sheet. The sheet may be any sheet as long as an image can be formed on the front surface of the sheet by the image forming apparatus 100.

The display 110 is an image display device such as a liquid crystal display (LCD), or an organic electro luminescence (EL) display. The display 110 displays various types of information items relating to the image forming apparatus 100.

The control panel 120 includes a plurality of buttons. The control panel 120 receives input of an operation from a user. The control panel 120 outputs a signal in accordance with the operation input by the user to a control unit of the image forming apparatus 100. The display 110 and the control panel 120 may be configured as an integrated touch panel.

The printer unit 130 forms an image on the sheet based on image information generated by the image reading unit 200 or image information received through a communication interface. The printer unit 130 forms an image by the following process, for example. An image forming unit of the printer unit 130 forms an electrostatic latent image on a photoreceptor drum based on the image information. The image forming unit of the printer unit 130 forms a visible image by applying a developer to the electrostatic latent image. As an example of the developer, toner may be used. A transfer unit of the printer unit 130 transfers the visible image to a sheet (different from a target sheet that was read). The fixing unit of the printer unit 130 fixes the visible image on the sheet by heating and pressing the sheet. The sheet on which the image is formed may be a sheet which is stored in the sheet housing unit 140. Alternatively, the sheet may be manually fed.

The sheet housing unit 140 stores the sheet to be used for forming an image in the printer unit 130.

The image reading unit 200 reads image information of a read target as brightness and darkness of light. The image reading unit 200 records the read image information. The recorded image information may be transmitted to the other information processing device through a network. The recorded image information may be formed as an image on the sheet by the printer unit 130.

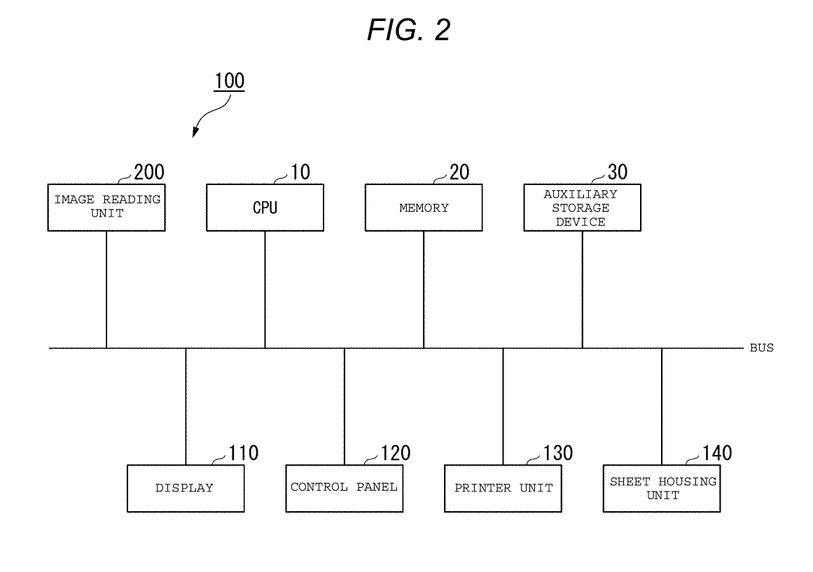

FIG. 2 illustrates an example schematic configuration of the image forming apparatus 100.

The image forming apparatus 100 includes a central processing unit (CPU) 10, a memory 20, and an auxiliary storage device 30 which is connected by a bus and executes a program. The image forming apparatus 100 includes the display 110, the control panel 120, the printer unit 130, the sheet housing unit 140, and the image reading unit 200, controlled by executing the program. The various functions or a part of the image forming apparatus 100 may be implemented using the hardware such as an application specific integrated circuit (ASIC), a programmable logic device (PLD), or a field programmable gate array (FPGA). The program may be recorded on a computer readable recording medium. The computer readable recording medium is, for example, a portable medium such as a flexible disk, a magnetic disk, a ROM, and a CD-ROM, and a storage device such as a hard disk equipped in a computer system. The program may be transmitted over a network connection.

The CPU 10 reads the program stored in the auxiliary storage device 30 to the memory 20 and executes the program. Thereby, the CPU 10 serves as a control unit for controlling each functional unit of the image forming apparatus 100. The CPU which serves as the control unit may be separate from each functional unit. For example, the CPU for controlling each functional of the image reading unit 200 may be provided in the image reading unit 200.

The memory 20 is, for example, a random access memory (RAM). The memory 20 temporarily stores data to be used by each functional unit provided in the image forming apparatus 100. The memory 20 may store digital data generated by the image reading unit 200.

The auxiliary storage device 30 is, for example, a hard disk or a solid state drive (SSD) and stores various types of data items. The various types of data items are, for example, image data. The image data is digital data generated by the image reading unit 200.

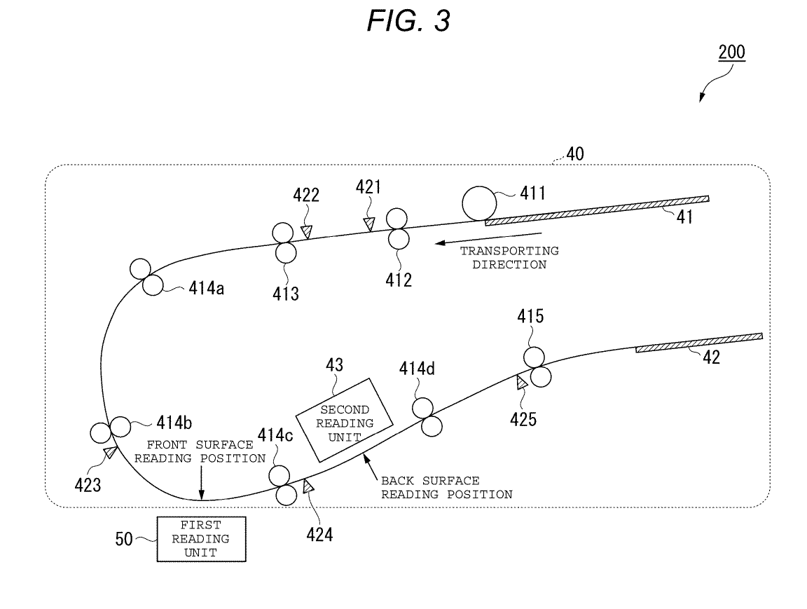

FIG. 3 illustrates an example internal configuration example of an image reading unit 200.

The image reading unit 200 includes an automatic document feeder (ADF) 40 and a first reading unit 50. Here, the ADF 40 functions as a reading device of a sheet back surface and the first reading unit 50 functions as a reading device of a sheet front surface.

The ADF 40 includes a sheet placement unit 41, a sheet feeding roller 411, a separation roller 412, a registration roller 413, a transporting roller 414a, a transporting roller 414b, a transporting roller 414c, a transporting roller 414d, a sheet discharging roller 415, a sheet discharging unit 42, and a second reading unit 43.

A sheet is initially positioned on the sheet placement unit 41.

The sheet feeding roller 411 feeds the sheet positioned on the sheet placement unit 41.

The separation roller 412 separates the sheets fed by the sheet feeding roller 411 one by one and feeds the sheet to the registration roller 413.

The registration roller 413 aligns a leading end of the sheet fed from the separation roller 412. The registration roller 413 sends the sheet in which the leading end is aligned in a sheet transport direction.

The transporting rollers 414a, 414b, 414c, and 414d send the sheet transported by the registration roller 413 in the sheet transport direction. In the following description, when the transporting rollers 414a, 414b, 414c, and 414d are not distinguished, the rollers are collectively described as the transporting roller 414.

The sheet discharging roller 415 sends the sheet transported by the transporting roller 414 to the sheet discharging unit.

The sheet discharging unit 42 stacks the sheet sent by the transporting roller 414.

The second reading unit 43 includes a light source lighting the back surface of the sheet and an image sensor such as a CCD or CIS. The second reading unit 43 generates image data of the back surface by lighting the back surface of the transported sheet with the light source and reading the back surface.

Furthermore, the ADF 40 includes various types of sensors for detecting the sheet moving on a transporting path. Specifically, the ADF 40 further includes a post-separation sensor 421, a registration sensor 422, a front surface position sensor 423, a rear surface position sensor 424, and a sheet discharging sensor 425.

The post-separation sensor 421 detects the sheet sent from the separation roller 412.

The registration sensor 422 detects the sheet which is transported to the registration roller 413.

The front surface position sensor 423 detects the sheet sent toward a reading position (hereinafter, referred to as a “front surface reading position”) of the first reading unit 50 from the transporting roller 414b.

The back surface position sensor 424 detects the sheet sent toward a reading position (hereinafter, referred to as a “back surface reading position”) of the second reading unit 43 from the transporting roller 414c.

The sheet discharging sensor 425 detects the sheet sent from the sheet discharging roller 415 toward the sheet discharging unit 42.

The first reading unit 50 includes a light source lighting the front surface of the sheet displaced on the sheet placement unit 41 and an image sensor such as a CCD or CIS. The first reading unit 50 generates image data of the front surface by lighting the front surface of the sheet displaced on the sheet placement unit 41 with the light source and reading the back surface.

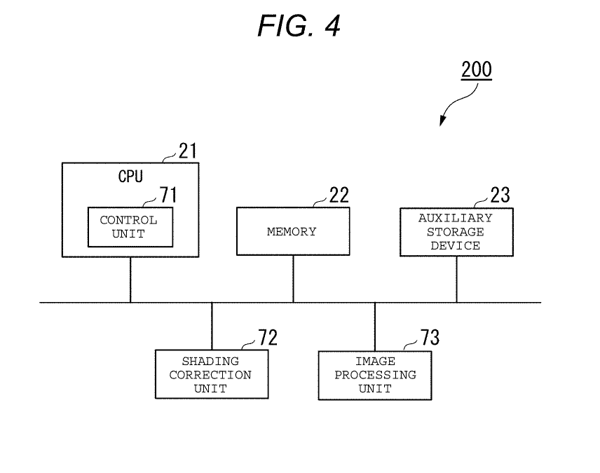

FIG. 4 illustrates an example functional-block configuration of the image reading unit 200.

The image reading unit 200 includes a CPU 21, a memory 22, and an auxiliary storage device 23 which is connected by a bus and executes a program. The image reading unit 200 includes the control unit 71, a shading correction unit 72, and an image processing unit 73, implemented by executing the program. The various functions or a part of the various functions of the image reading unit 200 may be implemented using the hardware such as an ASIC, a PLD, or a FPGA. The program may be recorded on a computer readable recording medium. The computer readable recording medium is, for example, a portable medium such as a flexible disk, a magnetic-optical disk, a ROM, and a CD-ROM, or a storage device such as a hard disk equipped in a computer system. The program may be transmitted over a network connection.

The CPU 21 reads the program stored in the auxiliary storage device 23 to the memory 22 and executes the program. Thereby, the CPU 21 serves as the control unit 71 for controlling each functional unit of the image reading unit 200. The CPU 21 can transmit and receive control information between the CPU 21 and the CPU 10 by communicating with the CPU 10. By transmitting and receiving the control information, the CPU 21 can operate the image reading unit 200 as a part of the image forming apparatus 100.

The memory 22 is, for example, a random access memory (RAM). The memory 22 temporarily stores data to be used by each functional unit provided in the image reading unit 200. The memory 22 may store digital data generated by the first reading unit 50 or the second reading unit 43.

The auxiliary storage device 23 is, for example, a hard disk or a solid state drive (SSD), and stores various types of data items. The various types of data items are, for example, image data. The image data is digital data generated by the first reading unit 50 or the second reading unit 43. The various types of data items may be stored in the auxiliary storage device 30 illustrated in FIG. 2. In such a case, the image reading unit 200 may not include the auxiliary storage device 23.

The control unit 71 controls the operation of each functional unit provided in the image reading unit 200. For example, the control unit 71 controls various rollers provided in the image reading unit 200 or operations of the first reading unit 50, the second reading unit 43, the shading correction unit 72, and the image processing unit 73.

The shading correction unit 72 executes a shading correction relating to reading of the front surface and the back surface of the sheet. The shading correction is a process for correcting a gain according to characteristics of a reading unit such that an unevenness of the image in the read image data is avoided. Information indicating a reference color used when correcting the gain (hereinafter, referred to as “reference data”) is required for performing the shading correction. The reference color for the correction is generally white or black. Reference plates having a white serving as a reference for the correction are provided in the first reading unit 50 and the second reading unit 43. The white reference data is acquired based on image data obtained by imaging the reference plates provided in the first reading unit 50 and the second reading unit 43, respectively. In addition, the black reference data is acquired based on the image data which is obtained by imaging with the first reading unit 50 and the second reading unit 43 in a state where the light source is turned off. When the image information of the sheet is generated, the shading correction unit 72 corrects the gains of the first reading unit 50 and the second reading unit 43 by acquiring the reference data that was generated before the sheet is read.

The image processing unit 73 (an example of a skew correction unit) performs various types of image processes for the acquired image data. For example, the image processing unit 73 performs a process for correcting the brightness of the image, a process for emphasizing an outline of the image, a process for reducing a noise, or the like. In addition to the process, the image processing unit 73 of the embodiment performs the skew correction for correcting distortion (hereinafter, referred to as skew) of the acquired image of the sheet to the image data. The skew correction is implemented by detecting an edge of the sheet from the image data and geometrically deforming an image based on the position of the detected edge.

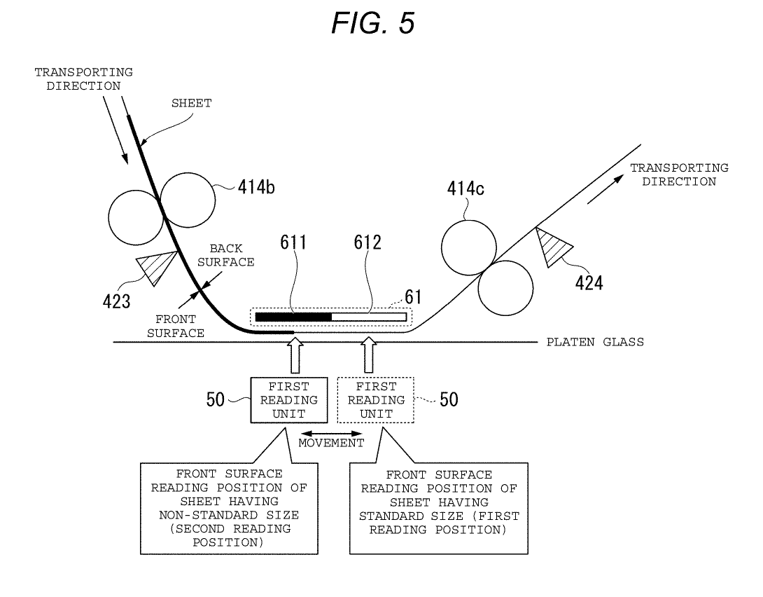

FIG. 5 illustrates a reading position of the first reading unit 50.

The first reading unit 50 includes a front surface guide 61 serving as a guide for the sheet when the sheet front surface is read. The front surface guide 61 includes a first guide unit 611 and a second guide unit 612. The first guide unit 611 is a guide used for a back surface of the sheet in the reading of the non-standard sized sheet. On the other hand, the second guide unit 612 is a guide used for a back surface of the sheet in the reading of the standard sized sheet. The first guide unit 611 serves as background for the sheet in the reading of the non-standard sized sheet. Specifically, the first guide unit 611 has a background color from which the outline of the non-standard sized sheet is distinguishable. For example, the first guide unit 611 has a black background color. The background color of the first guide unit 611 may be a color other than black as long as the background color can be distinguished from the outline of the non-standard sized sheet (generally, white) to be read. In addition, the first guide unit 611 may include a background pattern such as hatching instead of the background color as long as the pattern can be distinguished from the outline of the non-standard sized sheet (generally, white).

When the non-standard sized sheet is read, the control unit 71 moves the first reading unit 50 to a position (hereinafter, referred to as a “first reading position”) where the imaging unit of the first reading unit 50 faces the first guide unit 611. The first reading unit 50 performs an imaging operation in the first reading unit, so that the non-standard sized sheet is read with the first guide unit 611 set as the background.

On the other hand, when the standard sized sheet is read, the control unit 71 moves the first reading unit 50 to a position (hereinafter, referred to as a “second reading position”) where the imaging unit of the first reading unit 50 faces the second guide unit 612.

The front surface guide 61 may include a reference plate used for performing the shading correction described above. For example, the front surface guide 61 may include a third guide unit serving as a reference plate in addition to the first guide unit 611 and the second guide unit 612. In this case, when the shading correction of the first reading unit 50 is performed, the control unit 71 moves the first reading unit 50 to the position (hereinafter, referred to as a “third reading position”) where the imaging unit of the first reading unit 50 faces the third guide unit. The first reading unit 50 acquires the image of the reference surface to acquire the reference data by performing the imaging operation in the third reading position.

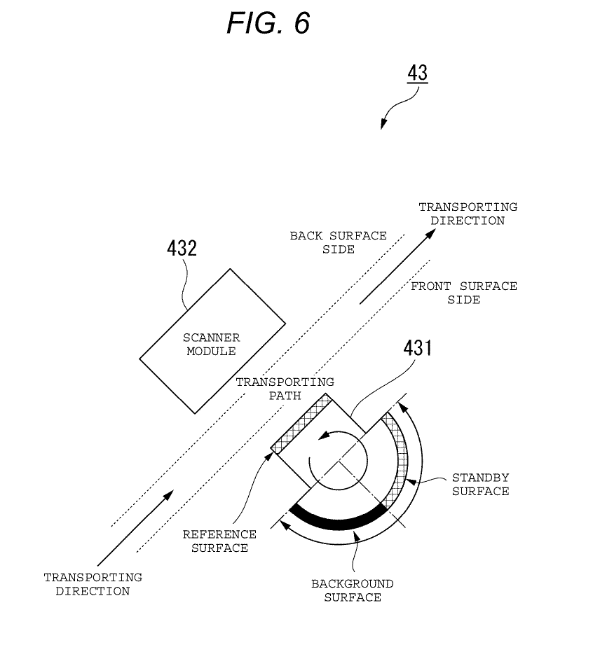

FIG. 6 illustrates a reading position of the second reading unit 43.

The second reading unit 43 includes a reference roller 431 (an example of the background unit) and a scanner module 432.

When the sheet back surface is read, the reference roller 431 serves as a guide for the sheet and also includes a reference surface for acquiring the reference data used to perform the shading correction. Among the roller surfaces of the reference roller 431, an area other than the reference surface is referred to as a standby surface. For example, as illustrated in FIG. 6, the reference roller 431 includes one half of the roller surface as the reference surface and the other half of the roller surface as the standby surface.

The reference roller 431 can be rotated with respect to the paper surface by controlling the driving unit (for example, a motor or the like) by the control unit 71. By rotating, the reference roller 431 can change the positions of the reference surface and the standby surface with respect to the scanner module 432. When the reference data is acquired, the control unit 71 rotates the reference roller 431 so that the scanner module 432 faces the reference surface. On the other hand, when the reference data is not acquired, the control unit 71 rotates the reference roller 431 so that the scanner module 432 faces the standby surface. By controlling the reference roller 431, the image forming apparatus 100 can control a contaminant that may adhere to the reference surface due to contact with a sheet or the like.

In addition, the standby surface of the reference roller 431 includes a background surface that serves as background for the read sheet. For example, as illustrated in FIG. 6, the reference roller 431 includes the background surface which occupies the half of the standby surface. The background surface has a background color (for example, black) which is distinguishable from the outline of the sheet in the same manner as with the first guide unit 611.

The scanner module 432 includes a light source for lighting the sheet to be read and an image sensor such as a CCD or CIS. The scanner module 432 generates image data of the sheet back surface by reading the back surface of the transported sheet. In addition, the scanner module 432 generates the reference data by imaging the reference surface with the lighting source turned on or imaging when the lighting source is turned off.

When the non-standard sized sheet is read, the control unit 71 controls the reference roller 431 so that the background surface is positioned facing the reading position of the scanner module 432. On the other hand, when the standard sized sheet is read, the control unit 71 controls the reference roller 431 such that the portion other than the background surface among the standby surface is positioned facing the reading position of the scanner module 432.

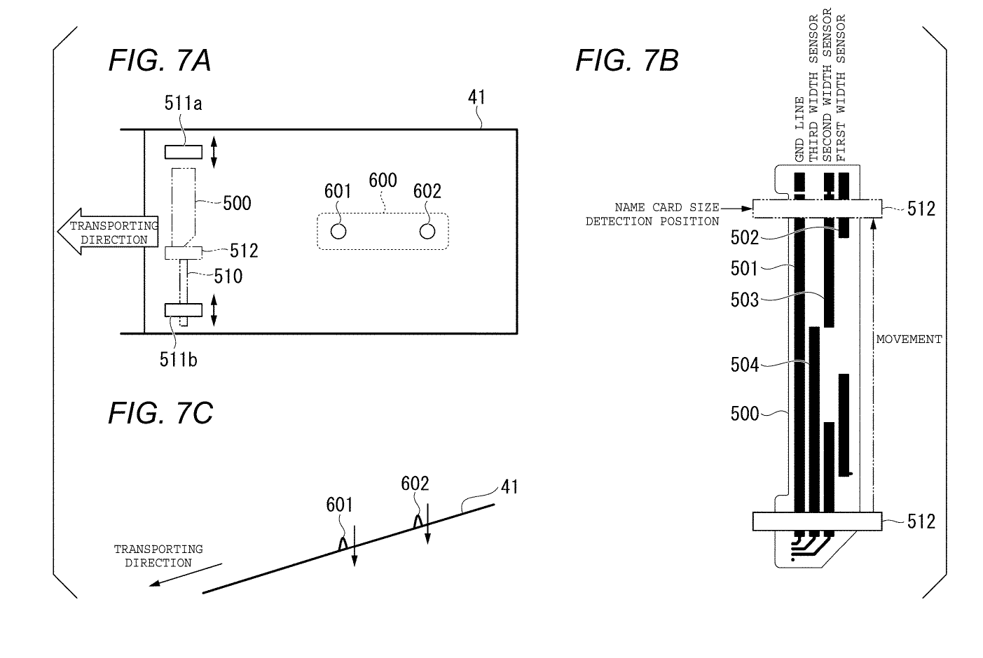

FIGS. 7A to 7C illustrating an example configuration in which the ADF 40 detects a size of a sheet. FIG. 7A illustrates the sheet placement unit 41 relating to detecting the size of the sheet.

The sheet placement unit 41 includes a width detection sensor 500, a connection unit 510, a width guide 511a, a width guide 511b, and a length detection sensor 600.

The width detection sensor 500 is a sensor for detecting the width of the sheet placed on the sheet placement unit 41. The width of the sheet is a width of the sheet in a direction perpendicular to the transporting direction.

The connection unit 510 is a rod-shaped member formed from a plastic. An end of the connection unit 510 is connected to the width guide 511b and moves in a width direction of the sheet according to the movement of the width guide 511b. In addition, a metallic portion 512 is capable of contacting the width detection sensor 500 according to the movement of the connection unit 510 and is included another end of the connection unit 510. That is, the metallic portion 512 is also moved in a width direction of the sheet according to the movement of the width guide 511b.

The width guide 511a and the width guide 511b align the sheets displaced on the sheet placement unit 41 in the width direction. The width guide 511a and the width guide 511b can be moved in the width direction of the sheet through electrically controlling or manual operating. The sheets are aligned in a width direction by moving the width guide 511a and the width guide 511b in the sheet direction in a state where the sheets are placed on the sheet placement unit 41.

The length detection sensor 600 is a sensor for detecting a length of the sheet displaced on the sheet placement unit 41. The length of the sheet is a length of the sheet in the transporting direction.

FIG. 7B illustrates a detailed example of the width detection sensor 500.

The width detection sensor 500 is provided at a lower portion of a stacking surface of the sheet placement unit 41. For example, the width detection sensor 500 includes a GND line 501 which is connected to a ground level. The width detection sensor 500 also includes a first width sensor 502, a second width sensor 503, and a third width sensor 504, each indicating a value of “0” or “1” according to a contact state between the sensors and the metallic portion 512. The first width sensor 502, the second width sensor 503, and the third width sensor 504 indicate “0” when the respective sensor is in contact with the metallic portion 512 and indicate “1” when the respective sensor is not in contact with the metallic portion 512. A signal is output from each sensor of the first width sensor 502, the second width sensor 503, and the third width sensor 504 and transmitted to the control unit 71 through a bus.

FIG. 7C illustrates a detailed example of the length detection sensor 600.

For example, the length detection sensor 600 is configured with a plurality of sensors disposed on the stacking surface 41 in the transporting direction (that is, a length direction). Each length sensor may be any sensor as long as the sensor can be in a state of ON or OFF according to the length of the sheet. For example, as the length sensor, an optical sensor may be used. In addition, a number of the length sensors may be disposed on the stacking surface 41 in accordance with the different lengths of sheet types to be detected.

FIG. 7B illustrates a first length sensor 601 and a second length sensor 602 as an example of the length detection sensor 600. The first length sensor 601 and the second length sensor 602 are in an ON state due to the sensors being pressed by the force of gravity from the sheet disposed on a stacking surface 41a. On the other hand, when the sheet is not disposed on the sheet placement unit 41, the first length sensor 601 and the second length sensor 602 are in an OFF state. The signal indicating the ON and OFF state of each length sensor is transmitted to the control unit 71 through the bus.

The control unit 71 can specify the size of the sheet by combining the signal output from width detection sensor 500 and the signal output from the length detection sensor 600.

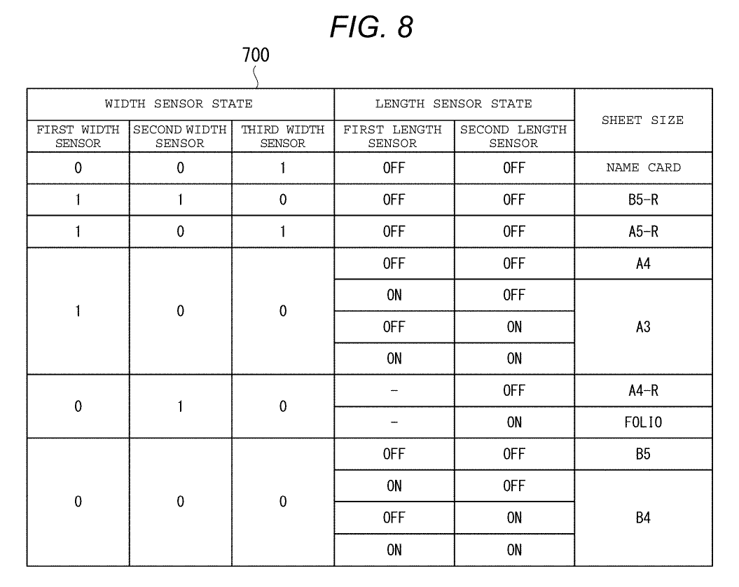

FIG. 8 illustrates an example table indicating a correspondence relationship between signal states of the width detection sensor 500 and the length detection sensor 600 and the size of the sheet. The image forming apparatus 100 stores a correspondence table 700 as illustrated in FIG. 8 to an internal storage region in advance. The control unit 71 can specify the sheet size by comparing the combination of outputs of the width detection sensor 500 and the length detection sensor 600 with the correspondence table 700.

For example, when a name card is displaced on the mounting unit 41, the metallic portion 512 is moved to a name card size detection position illustrated in FIG. 7(B) by the movement of the width guide 511b. In this case, the metallic portion 512 contacts the first width sensor 502 and the second width sensor 503 and the metallic portion 512 does not contact the third width sensor 504. Thus, the width detection sensor 500 is in a state where the first width sensor 502 and the second width sensor 503 indicate “0” and the third width sensor 504 indicates “1”. The correspondence table 700 illustrated in FIG. 8 indicates that the detection state of the width detection sensor 500 corresponds to the detection of the name card size.

The control unit 71 controls the first reading unit 50 and the reference roller 431 to set the position of the first reading unit 50 and the reference roller 431 in accordance with the detected sheet size, based on the sheet size detected by the detection mechanism.

When the sheet displaced on a platen glass is read, the image of the sheet to be input to an imaging unit (for example, CCD) of the first reading unit 50 is generated in accordance with the width and length of the detected sheet size, as measured by an internal sensor of the scanner.

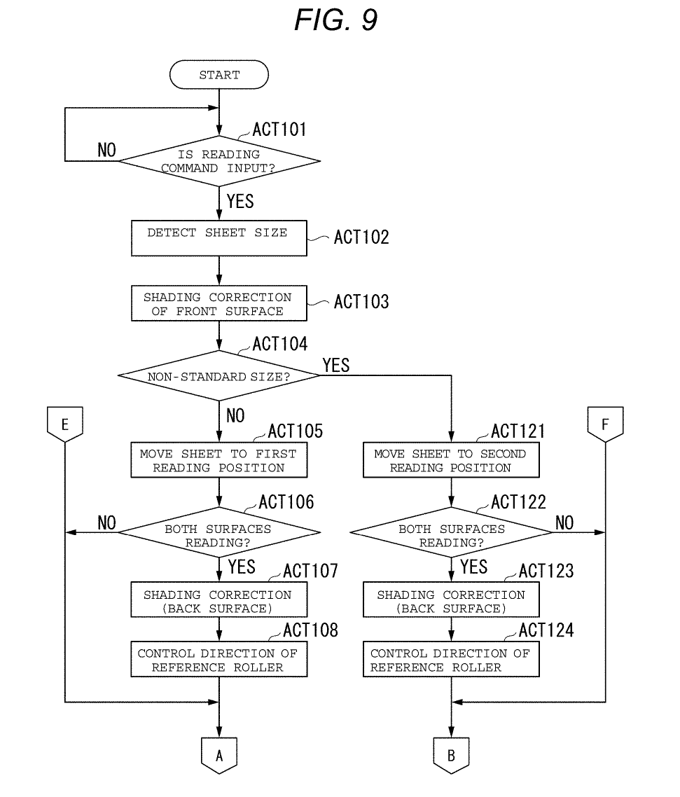

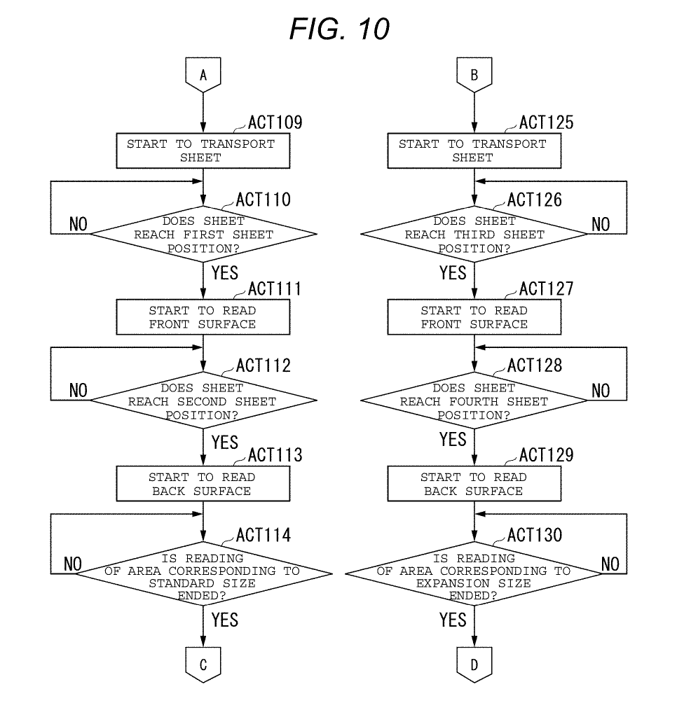

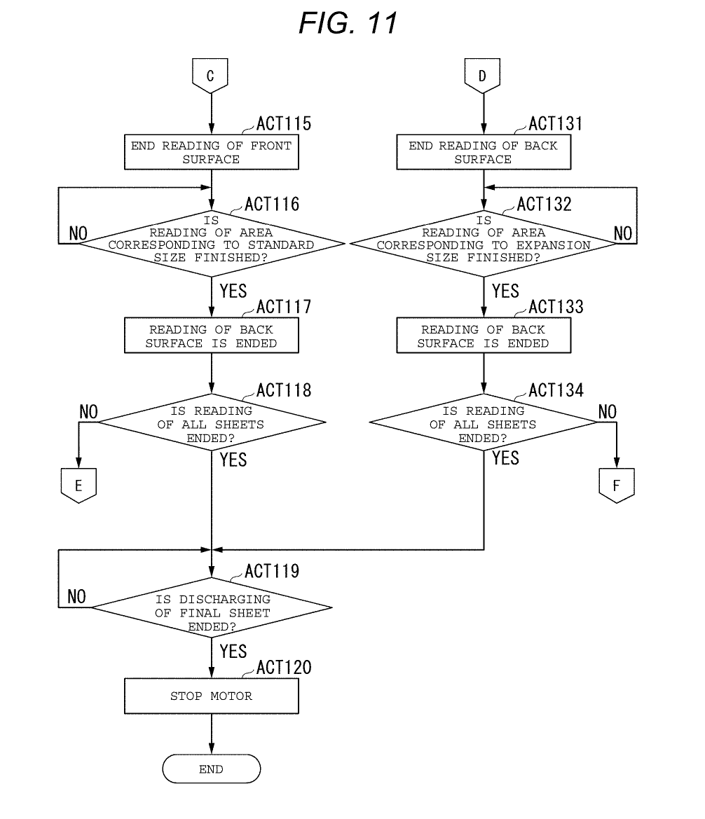

FIGS. 9, 10, and 11 are flowcharts illustrating an example sequence of operations when the image forming apparatus 100 of the embodiment reads the sheet. First, the control unit 71 determines whether a reading instruction (hereinafter, referred to as a “reading command”) of the sheet is input (ACT 101). When the reading command is not input (ACT 101: NO), the control unit 71 repeats ACT 101 until the control unit 71 receives the input of the reading command. When the reading command is input (ACT 101: YES), the control unit 71 detects the size of the sheet to be read (ACT 102). The control unit 71 executes a shading correction of the front surface for the first reading unit 50 and the shading correction unit 72 (ACT 103).

Subsequently, the control unit 71 determines whether the size of the sheet to be read is a non-standard size (ACT 104). For example, the control unit 71 can distinguish that the sheet size is the standard size or a non-standard size base on the information input from the control panel 120. For example, when the reading instruction of the name card is input from the control panel 120, the control unit 71 determines that the size of the sheet to be read is the non-standard size.

When the size of the sheet to be read is not the non-standard size (ACT 104: NO), that is, when the size of the sheet is the standard size, the control unit 71 executes a normal reading process. Specifically, the control unit 71 executes the following processes as the normal reading process.

First, the control unit 71 moves the first reading unit 50 to the first reading position (ACT 105). Subsequently, the control unit 71 determines whether the reading command includes an instruction to read the both surfaces of the sheet (ACT 106). When the reading command includes an instruction to read the both sides of the sheet (ACT 106: YES), the control unit 71 executes a shading correction of the back surface for the second reading unit 43 and the shading correction unit 72 (ACT 107). When the shading correction of the back surface is ended, the control unit 71 controls the reference roller 431 (ACT 108). Specifically, the control unit 71 rotates the reference roller 431 so that the standby surface faces the scanner module 432. Accordingly, the sheet back surface is read in a state where the back of the sheet is against the standby surface of the reference roller 431.

The control unit 71 starts transporting the sheet by operating the sheet feeding roller 411, the registration roller 413, and the transporting roller 414 (ACT 109).

Subsequently, the control unit 71 determines whether the sheet to be read reaches a first sheet position (ACT 110). Here, the first sheet position is a sheet position when a leading end portion of the sheet reaches the reading position of the first reading unit 50. The position of the sheet to be transported through the transporting path is detected by the various types of sensors which are disposed on the transporting path. For example, the position of the sheet to be transported in the ADF 40 is detected by the post-separation sensor 421, the registration sensor 422, the front surface position sensor 423, the back surface position sensor 424, and the sheet discharging sensor 425. Specifically, the control unit 71 detects that the leading end of the sheet has passed when the state of each sensor transitions from the OFF state to the ON state, and detects that the rear end of the sheet has passed when the state of each sensor transitions from the ON state to the OFF state.

When the sheet to be read does not reach the first sheet position (ACT 110: NO), the control unit 71 repeats ACT 110 until the sheet to be read reaches the first sheet position. When the sheet to be read reaches the first sheet position (ACT 110: YES), the control unit 71 causes the first reading unit 50 to start reading the sheet front surface (ACT 111).

Subsequently, the control unit 71 determines whether the sheet to be read reaches a second sheet position (ACT 112). Here, the second sheet position is a position when a leading end of the sheet reaches the reading position of the second reading unit 43. When the sheet to be read does not reach the second sheet position (ACT 112: NO), the control unit 71 repeats ACT 112 until the sheet to be read reaches the second sheet position. When the sheet to be read reaches the second sheet position (ACT 112: YES), the control unit 71 causes the second reading unit 43 to start reading the sheet back surface (ACT 113).

Subsequently, the control unit 71 determines whether the reading of an area corresponding to the detected standard size is finished (ACT 114). When the reading of the area corresponding to the detected standard size is not finished (ACT 114: NO), the control unit 71 continues the reading process of the front surface, repeating ACT 114. When the reading of the area corresponding to the detected standard size is finished (ACT 114: YES), the control unit 71 ends the reading of the sheet front surface (ACT 115).

In the same manner, the control unit 71 determines whether the reading of the back surface of the sheet corresponding to the detected standard size is finished (ACT 116). When the reading of the area corresponding to the detected standard size is not finished (ACT 116: NO), the control unit 71 continues the reading process of the back surface and repeats ACT 116. On the other hand, when the reading of the area corresponding to the detected standard size is finished (ACT 116: YES), the control unit 71 ends the reading of the sheet back surface (ACT 117).

Subsequently, the control unit 71 determines whether the reading of all the sheets to be read is finished (ACT 118). When the reading of a part of the sheets is not finished (ACT 118: NO), the control unit 71 returns the process to ACT 109, and starts transporting a next sheet to be read at a timing when the sheet does not come into contact with a preceding sheet. On the other hand, when the reading of all the sheets is finished (ACT 118: YES), the control unit 71 determines whether the discharging of the final sheet to be read (hereinafter, referred to as a “final sheet”) is finished (ACT 119). For example, after the reading of the final sheet is finished, the control unit 71 may determine whether the discharging of the final sheet is finished by determining whether a time required for the sheet to be discharged has passed.

When the discharging of the final sheet is not finished (ACT 119: NO), the control unit 71 repeats ACT 119 until the discharging of the final sheet is finished. When the discharging of the final sheet is finished (ACT 119: YES), the control unit 71 ends the reading process by stopping a motor for driving the various types of the rollers (ACT 120).

The above processes are the normal reading processes with respect to the standard sized sheet.

Subsequently, a flow of the reading process with respect to the non-standard sized sheet will be described.

In ACT 104, when it is determined that the size of the sheet to be read is the non-standard size (ACT 104: YES), the control unit 71 executes the reading process for a non-standard sized sheet. Specifically, the control unit 71 executes the following process as the reading process for the non-standard sized sheet.

Firstly, the control unit 71 moves the first reading unit 50 to the second reading position (ACT 121). Subsequently, the control unit 71 determines whether the reading command includes an instruction to read the both surfaces of the sheet (ACT 122). When the reading command includes an instruction to read the both sides of the sheet (ACT 122: YES), the control unit 71 executes the shading correction of the back surface for the second reading unit 43 and the shading correction unit 72 (ACT 123). When the shading correction of the back surface is ended, the control unit 71 controls the rotation of the reference roller 431 (ACT 124). Specifically, the control unit 71 rotates the reference roller 431 so that the background surface faces the scanner module 432. Accordingly, the sheet back surface is read in a state where the back of the sheet is against the background surface of the reference roller 431.

The control unit 71 starts transporting the sheet by operating the sheet feeding roller 411, the registration roller 413, and the transporting roller 414 (ACT 125).

Subsequently, the control unit 71 determines whether the sheet to be read reaches a third sheet position (ACT 126). Here, the third sheet position is at a predetermined distance from the first sheet position in a direction opposite to the transporting direction. That is, regarding the sheet which is in the third sheet position, the leading end of the sheet can be read at the timing when the sheet is transported at the predetermined distance in the transporting direction. For example, the control unit 71 may determine whether the sheet to be read reaches the third sheet position based on the elapsed time since the transporting of the sheet to be read is started.

When the sheet to be read does not reach the third sheet position (ACT 126: NO), the control unit 71 repeats ACT 126 until the sheet to be read reaches the third sheet position. When the sheet to be read reaches the third sheet position (ACT 126: YES), the control unit 71 causes the first reading unit 50 to start reading the sheet front surface (ACT 127).

In such a manner, by starting reading the sheet before the predetermined time when the leading end portion of the sheet is detected, it can prevent the image data of the leading end of the sheet from being deteriorated due to the generation of the skew.

Subsequently, the control unit 71 determines whether the sheet to be read reaches a fourth sheet position (ACT 128). Here, the fourth sheet position is at a predetermined distance from the second sheet position in a direction opposite to the transporting direction. That is, regarding the sheet which is in the fourth sheet position, the leading end of the sheet can be read at the timing when the sheet is transported at the predetermined distance in the transporting direction. For example, the control unit 71 may determine whether the sheet to be read reaches the fourth sheet position based on the elapsed time since the transporting of the sheet to be read is started.

When the sheet to be read does not reach the fourth sheet position (ACT 128: NO), the second reading unit 43 repeats ACT 128 until the sheet to be read reaches the fourth sheet position. When the sheet to be read reaches the fourth sheet position (ACT 128: YES), the second reading unit 43 starts reading the back surface of the sheet to be read (ACT 129).

Here, the second reading unit 43 performs the reading operation for the sheet to be read by reading an area (hereinafter, referred to as an “expansion size”) greater than the detected non-standard size. Therefore, the image data including the entire sheet can be acquired, even when the non-standard sized sheet is slightly greater than the standard size or when the non-standard sized sheet is skewed.

Specifically, regarding the sheet front surface, the control unit 71 determines whether the reading of the area corresponding to the expansion size is finished (ACT 130). When the reading of the sheet corresponding to the expansion area is not finished (ACT 129: NO), the control unit 71 continues the reading process of the front surface and repeats ACT 130. On the other hand, when the reading of the area corresponding to the expansion size is finished (ACT 130: YES), the control unit 71 ends the reading of the sheet front surface (ACT 131).

In the same manner, regarding the sheet back surface, the control unit 71 determines whether the reading of the area corresponding to the expansion size is finished (ACT 132). When the reading of the area corresponding to the expansion size is not finished (ACT 132: NO), the control unit 71 continues the reading process of the back surface and repeats ACT 132. On the other hand, when the reading of the area corresponding to the expansion size is finished (ACT 132: YES), the control unit 71 ends the reading of the sheet back surface (ACT 133).

Subsequently, the control unit 71 determines whether the reading of all the sheets to be read is finished (ACT 134). When the reading of a part of the sheets is not finished (ACT 134: NO), the control unit 71 returns the process to ACT 125, and starts transporting a next sheet to be read. On the other hand, when the reading of all the sheets is finished (ACT 134: YES), the control unit 71 moves the process to ACT 119 and ends the reading process.

In the reading of the non-standard sized sheet, the image forming apparatus 100 of the embodiment suppresses formation of the image in which a part of the sheet is missing. Specifically, when reading the non-standard sized sheet, the image forming apparatus 100 starts reading at an earlier timing compared to the normal timing. Therefore, the timing of the reading is adjusted so that the leading end of the sheet is reliably included in the image data, even when the sheet is skewed.

In addition, when reading the non-standard sized sheet, the image forming apparatus 100 reads an area having an expansion size greater than the detected non-standard size. By this reading operation, the image forming apparatus 100 can further reliably read the entire non-standard sized sheet.

In addition, when reading the non-standard sized sheet, the image forming apparatus 100 reads the sheet using the background surface that has a color that can be distinguished from the outline of the sheet as a background. Therefore, when the sheet is skewed, the image forming apparatus 100 can further correctly extract the entire image of the sheet from the image data. Accordingly, by performing the skew correction for the extracted image of the sheet, the image forming apparatus 100 can generate a correct image of the non-standard sized sheet.

Hereinafter, a modification example of the image reading apparatus, the image reading method, and the image forming apparatus of the embodiment will be described.

The image reading unit 200 which is provided on the image forming apparatus 100 of the above-described embodiment may be configured as an image reading apparatus which is independent from the image forming apparatus 100.

The image forming apparatus 100 of the above-described embodiment may further include a heating unit for decoloring an image formed using a decolorable toner for decoloring by heating the sheet. In this case, the heating unit may be obtained by a fixing unit of the printer unit 130.

A name card size of the above-described embodiment is an example of a sheet size (non-standard size) smaller than the standard size. The non-standard size may be any sheet size other than the name card size as long as the sheet size is smaller than the standard size.

In this embodiment, “decoloring” means to make it difficult to recognize a color of an image formed on an image receiving member after the image is formed on the image receiving member by a recording material which has different color from the color of the image receiving material. The color of recording material may be any color including black, white or a chromatic color.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and their equivalents are intended to cover such forms or modifications as would fall within the scope and spirit of the invention.

1. An image reading apparatus comprising:
an image reading device configured to generate image data by reading an object;
a reference roller having a plurality of different background surfaces; and
a processor configured to:
determine whether the object has a standard size, and
control at least one of the image reading device and the reference roller so that
when the object is determined to not have a standard size, the image reading device faces the object with a first surface, of the plurality of different background surfaces that is distinguishable from the object, positioned behind the object for reading, and
when the object is determined to have a standard size, the image reading device faces the object with a second surface, with a different color than the first surface of the plurality of different background surfaces, positioned behind the object for reading.

2. The apparatus according to claim 1, wherein, when the object is determined to not have a standard size, the control unit controls the image reading device to start the reading at a timing before the object is transported to a reading position of the image reading device.

3. The apparatus according to claim 2, wherein the timing is set so that an entirety of a skewed leading end of the object in a transporting direction is included in the generated image data.

4. The apparatus according to claim 1, when the object is determined to not have a standard size, the control unit controls the image reading device to read an area larger than a size of the object.

5. The apparatus according to claim 1, wherein:
a third surface of the plurality of different background surfaces is a reference surface,
the control unit further controls at least one of the image reading device and the reference roller so that the image reading unit reads the third surface to acquire reference data for shading correction of image data, and
the control unit performs the shading correction on the generated image data based on the reference data.

6. The apparatus according to claim 1, wherein the processor is further configured to:
detect an edge of the object in the image data read from the non-standard sized object, and
correct a skew of the image data based on the detected edge.

7. The apparatus according to claim 1, wherein the reference roller is selectively rotatable so that one of the first surface and second surface is positioned behind the object.

8. The apparatus according to claim 1, wherein the processor controls the image reading device to selectively move between a first position in which the first surface is behind the object for reading and a second position in which the second surface is behind the object for reading.

9. An image forming apparatus comprising:
an image reading device configured to generate image data by reading an object;
a reference roller having a plurality of different background surfaces;
an image forming unit that forms an image on a sheet based on the generated image data; and
a processor configured to:
determine whether the object has a standard size, and
control at least one of the image reading device and the reference roller so that
when the object is determined to not have a standard size, the image reading device faces the object with a first surface, of the plurality of different background surfaces that is distinguishable from the object, positioned behind the object for reading, and
when the object is determined to have a standard size, the image reading device faces the object with a second surface, with a different color than the first surface of the plurality of different background surfaces, positioned behind the object for reading.

10. The apparatus according to claim 9, wherein, when the object is determined to not have a standard size, the processor controls the image reading device to start the reading at a timing before the object is transported to a reading position of the image reading device.

11. The apparatus according to claim 10, wherein the timing is set so that an entirety of a skewed leading end of the object in a transporting direction is included in the generated image data.

12. The apparatus according to claim 9, when the object is determined to not have a standard size, the processor controls the image reading device to read an area larger than a size of the object.

13. The apparatus according to claim 9, wherein:
a third surface of the plurality of different background surfaces is a reference surface,
the processor further controls at least one of the image reading device and the reference roller so that the image reading device reads the third surface to acquire reference data for shading correction of image data, and
the processor performs the shading correction on the generated image data based on the reference data.

14. The apparatus according to claim 13, wherein the reference roller is selectively rotatable so that one of the first surface and the second surface is positioned behind the object for reading, and so that the third surface is positioned facing the image reading device for acquiring the reference data.

15. The apparatus according to claim 9, wherein the processor is further configured to:
detect an edge of the object in the image data read from the non-standard sized object, and
correct a skew of the image data based on the detected edge.

16. The apparatus according to claim 9, wherein the reference roller is selectively rotatable so that one of the first surface and second surface is positioned behind the object.

17. A method for generating image data comprising the steps of:
determining whether an object to be read has a standard size;
controlling at least one of an image reading device configured to read the object and a reference roller having a plurality of different background surfaces so that:
when the object is determined to not have a standard size, a first surface, of the plurality of different background surfaces that is distinguishable from the object, is positioned behind the object, and
when the object is determined to have a standard size, a second surface, with a different color than the first surface of the plurality of different background surfaces, is positioned behind the object; and
generating image data by reading the object with the first surface or the second surface positioned behind the object.

18. The method according to claim 17, wherein, when the object is determined to not have a standard size, the image reading device starts the reading at a timing before the object is transported to a reading position of the image reading device.

19. The method according to claim 18, wherein the timing is set so that an entirety of a skewed leading end of the object in a transporting direction is included in the generated image data.

20. The method according to claim 19, further comprising the steps of:
detecting an edge of the object in the image data read from the non-standard sized object; and
correcting a skew of the image data based on the detected edge.
